(19) United States
(12) Patent Application Publication
(10) Pub. No.: US 2018/0300343 A1
(43) Pub. Date: Oct. 18, 2018

(54) METHOD AND DEVICE FOR ACQUIRING PICTURE

(71) Applicant: BEIJING KINGSOFT INTERNET SECURITY SOFTWARE CO., LTD., Beijing (CN)

(72) Inventor: Zhongsheng Wu, Beijing (CN)

(73) Assignee: BEIJING KINGSOFT INTERNET SECURITY SOFTWARE CO., LTD., Beijing (CN)

(21) Appl. No.: 16/013,563

(22) Filed: Jun. 20, 2018

Related U.S. Application Data
(63) Continuation of application No. PCT/CN2016/083475, filed on May 26, 2016.

(30) Foreign Application Priority Data
Dec. 25, 2015 (CN) 201510998064.X

(51) Int. Cl. G06F 17/30; G06Q 20/12

(52) U.S. Cl. CPC G06F 17/3087; G06Q 20/123; G06F 17/30244

(57) ABSTRACT

The present disclosure provides a method and a device for acquiring a picture. The method includes: receiving a first request sent by a first terminal, wherein the first request comprises content information of a target picture and geographic location information for acquiring the target picture; determining a target terminal according to the geographic location information and location information of each terminal, wherein a distance between the target terminal and a geographic location indicated by the geographic location information is within a set distance threshold; sending a second request to the target terminal, wherein the second request comprises the content information of the target picture; receiving at least one picture sent by the target terminal according to the second request; and determining the target picture in the received at least one picture, and sending the target picture to the first terminal.

### CROSS-REFERENCE TO RELATED APPLICATIONS

This application is a continuation application of International Application No. PCT/CN 2016/083475, which claims priority to and benefits of Chinese Patent Application No. 201510998064.X, filed with the State Intellectual Property Office of P. R. China on Dec. 25, 2015, the entire contents of which are incorporated herein by reference.

### FIELD

The present disclosure relates to the field of internet technology, and more particularly, to a method and a device for acquiring a picture.

### BACKGROUND

At present, when users need to acquire pictures taken at a specific place, they can only search on the internet for related pictures in a database. However, most of pictures in the database are taken a long time ago, which results in a big difference between the subject in the picture and the subject in reality, and user satisfaction is low.

### SUMMARY

Embodiments of the present disclosure provide a method for acquiring a picture, which is applied to a server. The method includes: receiving a first request sent by a first terminal, in which the first request includes content information of a target picture and geographic location information for acquiring the target picture; determining a target terminal according to the geographic location information and location information of each terminal, in which a distance between the target terminal and a geographic location indicated by the geographic location information is within a set distance threshold; sending a second request to the target terminal, in which the second request includes the content information of the target picture; receiving at least one picture sent by the target terminal according to the second request; determining the target picture in the received at least one picture, and sending the target picture to the first terminal.

Embodiments of the present disclosure provide a device for acquiring a picture, which is applied to a server. The device includes a first receiving module, a first determining module, a first sending module, a second receiving module, a second determining module and a second sending module.

The first receiving module is configured to receive a first request sent by a first terminal. The first request includes content information of a target picture and geographic location information for acquiring the target picture.

The first determining module is configured to determine a target terminal according to the geographic location information and location information of each terminal. A distance between the target terminal and a geographic location indicated by the geographic location information is within a set distance threshold.

The first sending module is configured to send a second request to the target terminal. The second request includes the content information of the target picture.

The second receiving module is configured to receive at least one picture sent by the target terminal according to the second request.

The second determining module is configured to determine the target picture in the received at least one picture.

The second sending module is configured to send the target picture to the first terminal.

Embodiments of the present disclosure further provide a server. The server includes a housing, a processor, a memory, a circuit board and a power supply circuit. The circuit board is disposed in a space enclosed by the housing. The processor and the memory are positioned on the circuit board. The power supply circuit is configured to provide power for respective circuits or components of the mobile terminal. The memory is configured to store executable program codes. The processor is configured to run a program corresponding to the executable program codes by reading the executable program codes stored in the memory, to perform following operations: receiving a first request sent by a first terminal, in which the first request includes content information of a target picture and geographic location information for acquiring the target picture; determining a target terminal according to the geographic location information and location information of each terminal, in which a distance between the target terminal and a geographic location indicated by the geographic location information is within a set distance threshold; sending a second request to the target terminal, in which the second request includes the content information of the target picture; receiving at least one picture sent by the target terminal according to the second request; and determining the target picture in the received at least one picture, and sending the target picture to the first terminal.

Embodiments of the present disclosure provide a computer readable storage medium, having instructions stored therein. When a processor of a terminal executes the instructions, the terminal executes the method for acquiring a picture described above.

Embodiments of the present disclosure provide a computer program, configured to perform the method for acquiring a picture described above when executed by a processor.

Certainly, any product or method for implementing the present disclosure may not need to reach all the advantages described above.

### BRIEF DESCRIPTION OF THE DRAWINGS

In order to clearly illustrate technical solutions in embodiments of the present disclosure or in the related art, the drawings used in embodiments or the related art will be briefly described below. Obviously, the drawings in the following descriptions are only part embodiments of the present disclosure, and for those skilled in the art, other drawings can be obtained according to these drawings without creative labor, in which:

FIG. 1 is a first flow chart of a method for acquiring a picture according to an embodiment of the present disclosure;

FIG. 2 is a second flow chart of a method for acquiring a picture according to an embodiment of the present disclosure;

FIG. 3 is a third flow chart of a method for acquiring a picture according to an embodiment of the present disclosure;

FIG. 4 is a fourth flow chart of a method for acquiring a picture according to an embodiment of the present disclosure;

FIG. 5 is a fifth flow chart of a method for acquiring a picture according to an embodiment of the present disclosure;

FIG. 6 is a first block diagram of a device for acquiring a picture according to an embodiment of the present disclosure;

FIG. 7 is a second block diagram of a device for acquiring a picture according to an embodiment of the present disclosure;

FIG. 8 is a third block diagram of a device for acquiring a picture according to an embodiment of the present disclosure;

FIG. 9 is a fourth block diagram of a device for acquiring a picture according to an embodiment of the present disclosure;

FIG. 10 is a fifth block diagram of a device for acquiring a picture according to an embodiment of the present disclosure; and

FIG. 11 is a schematic diagram of a server according to an embodiment of the present disclosure.

### DETAILED DESCRIPTION

Reference will be made clearly and completely technical solutions in the embodiments of the present disclosure with accompanying drawings. Obviously, the embodiments described here are only part of the embodiments of the present disclosure and are not all embodiments of the present disclosure. Based on the embodiments of the present disclosure, other embodiments obtained by those skilled in the art without creative labor are within scope of the present disclosure.

In order to solve problems in the related art, embodiments of the present disclosure provide a method and a device for acquiring a picture, which are applied to a server. In the following, the method for acquiring a picture provided in embodiments of the present disclosure will be described first.

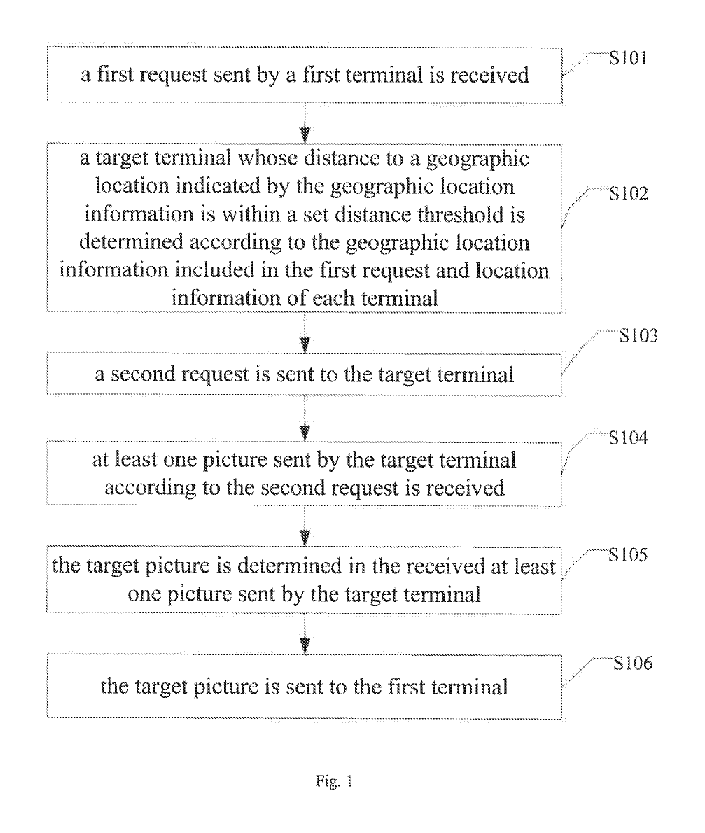

FIG. 1 is a first flow chart of a method for acquiring a picture according to an embodiment of the present disclosure, which may include followings.

At block S101, a first request sent by a first terminal is received. The first request includes content information of a target picture and geographic location information for acquiring the target picture.

At block S102, a target terminal whose distance to a geographic location indicated by the geographic location information is within a set distance threshold is determined according to the geographic location information included in the first request and location information of each terminal.

At block S103, a second request is sent to the target terminal. The second request includes content information of the target picture.

At block S104, at least one picture sent by the target terminal according to the second request is received.

At block S105, the target picture is determined in the received at least one picture.

At block S106, the target picture is sent to the first terminal.

Assuming that the first terminal needs to acquire a sunset picture taken at a location B, and then the content information of the picture to be acquired (i.e., the target picture) is sunset, the geographic location information for indicating geographic location B and for acquiring the picture to be acquired is “B”.

The first request sent by the first terminal is received, and the first request includes content information “sunset” of the picture to be acquired and geographic location information “B” for indicating the geographic location B and for acquiring the picture to be acquired.

The target terminal whose distance to the geographic location B is within the set distance threshold is determined. In detail, assuming that the distance threshold is 1 km, and then a terminal whose distance to B is less than 1 km is determined as the target terminal.

In an actual application, the location information of each terminal can be acquired through a GPS (Global Positioning System), and this is technology in the related art, which will not be described herein again.

A second request is sent to the target terminal determined above. The second request includes content information “sunset” of the picture to be acquired.

Pictures sent by the target terminal are received, and the target picture is determined in the received pictures.

In an actual application, a way of determining the target picture may include determining any picture in the received at least one picture as the target picture.

In an actual application, a way of determining the target picture may also include filtering the received at least one picture, and determining the target picture in the filtered at least one picture. In detail, the pictures may be filtered by setting a resolution threshold, and a picture with a resolution less than the threshold may be filtered out, and then the target picture can be determined in the filtered pictures.

The determined target picture is sent to the first terminal.

By applying embodiments illustrated in FIG. 1 of the present disclosure, a first request for acquiring a target picture sent by a first terminal is received, the first request includes content information of the target picture and geographic location information for acquiring the target picture, a target terminal whose distance to a geographic location indicated by the geographic location information is within the set distance threshold is determined, and the request for acquiring the target picture is sent to the target terminal, the target picture is determined from pictures sent by the target terminal, and the target picture is sent to the first terminal that needs to acquire the target picture, latest pictures taken by users at a certain geographic location can be acquired in real time, and user satisfaction can be improved.

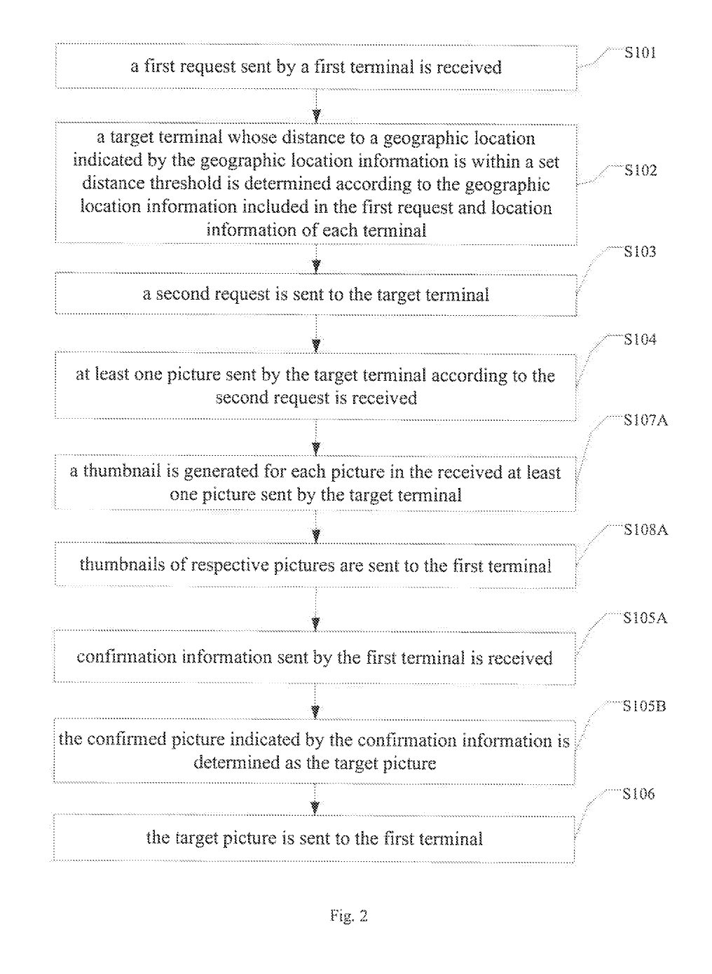

FIG. 2 is a second flow chart of a method for acquiring a picture according to an embodiment of the present disclosure. Embodiments illustrated in FIG. 2 are based on the embodiments illustrated in FIG. 1 of the present disclosure, block S107A and S108A are added before block S105.

At block S107A, a thumbnail is generated for each picture in the received at least one picture sent by the target terminal.

At block S108A, thumbnails of respective pictures are sent to the first terminal.

Block S105 may include block S105A and block S105B.

At block S105A, confirmation information sent by the first terminal is received. The confirmation information includes information of confirmed picture.

At block S105B, the confirmed picture indicated by the confirmation information is determined as the target picture.

Assuming that four pictures sent by the target terminal are received, which are a picture 1, a picture 2, a picture 3 and a picture 4, respectively. Thumbnails of these four pictures are generated, and the thumbnails of the four pictures are sent to the first terminal. The first terminal receives the thumbnails of these four pictures and selects one from them. Assuming that the thumbnail of the picture 3 is selected, and then the picture 3 is taken as the confirmed picture, and confirmation information is sent to the server. The server receives the confirmation information sent by the first terminal, the confirmation information includes information of taking the picture 3 as the confirmed picture, and then the picture 3 is determined as the target picture.

In embodiments of the present disclosure, the received at least one picture sent by the target terminal can be filtered, and the target picture can be determined in the filtered at least one picture. In detail, the pictures may be filtered by setting a resolution threshold, and a picture with a resolution less than the threshold may be filtered out, and then the target picture can be determined in the filtered pictures.

Assuming that four pictures sent by the target terminal are received, which are a picture 1, a picture 2, a picture 3 and a picture 4, respectively. The resolution of the picture 1 is 800×600, the resolution of the picture 2 is 1024×768, the resolution of the picture 3 is 320×240, the resolution of the picture 4 is 800×600, the set resolution threshold is 800×600, and then the picture 3 with the resolution less than the threshold may be filtered out, and thumbnails of the picture 1, the picture 2 and the picture 4 can be generated and sent to the first terminal.

The first terminal receives the thumbnails of these three pictures and selects one from them. Assuming that the thumbnail of the picture 2 is selected, and then the picture 2 is taken as the confirmed picture, and confirmation information is sent to the server. The server receives the confirmation information sent by the first terminal, the confirmation information includes information of taking the picture 2 as the confirmed picture, and the picture 2 is determined as the target picture.

By applying embodiments illustrated in FIG. 2 of the present disclosure, a first request for acquiring a target picture sent by a first terminal is received, the first request includes content information of the target picture and geographic location information for acquiring the target picture, a target terminal whose distance to a geographic location indicated by the geographic location information is within the set distance threshold is determined, and the request for acquiring the target picture is sent to the target terminal, thumbnails of pictures are generated according to the pictures sent by the target terminal, and the thumbnails of the pictures are sent to the first terminal to allow the first terminal to select, the target picture is determined according to the selection of the first terminal, and the target picture is sent to the first terminal that needs to acquire the target picture, latest pictures that users need can be acquired in real time, and user satisfaction can be improved.

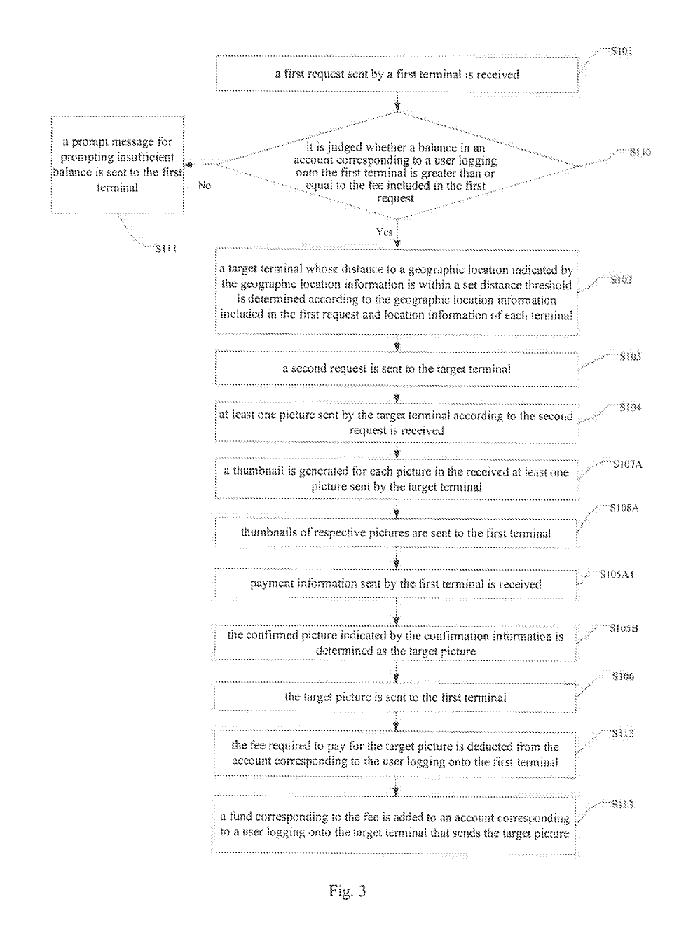

FIG. 3 is a third flow chart of a method for acquiring a picture according to an embodiment of the present disclosure. Embodiments illustrated in FIG. 3 are based on the embodiments illustrated in FIG. 2 of the present disclosure. The server includes accounts corresponding to users logging onto respective terminals, and each of the first request and the second request further includes a fee required to pay for the target picture. After block S101, followings may be included.

At block S110, it is judged whether a balance in an account corresponding to a user logging onto the first terminal is greater than or equal to the fee included in the first request, if yes, block S102 is performed, and if no, block S111 is performed.

At block S111, a prompt message for prompting insufficient balance is sent to the first terminal.

Block S105A may include block S105A1. At block 105A1, payment information sent by the first terminal is received. The payment information includes information of the confirmed picture and payment confirmation information of the confirmed picture.

After block S105B, followings may be included.

At block S112, the fee required to pay for the target picture is deducted from the account corresponding to the user logging onto the first terminal.

At block S113, a fund corresponding to the fee is added to an account corresponding to a user logging onto the target terminal that sends the target picture.

In an actual application, in order to increase a response rate of the target terminal, each of the first request and the second request may include the fee required to pay for the target picture. Correspondingly, the server may include accounts corresponding to users logging onto respective terminals.

Assuming that the fee required to pay for the target picture is “50 RMB”, and the first request includes content information “sunset” of the target picture, geographic location information “B” for acquiring the target picture and “50 RMB” required to pay for the target picture. After the first request is received, it is judged whether a balance in the account corresponding to the user logging onto the first terminal is greater than or equal to 50 RMB required to pay for the target picture. Assuming that the balance in the account corresponding to the user logging onto the first terminal is 20 RMB, a prompt message for prompting insufficient balance may be sent to the first terminal. Assuming that the balance in the account corresponding to the user logging onto the first terminal is 80 RMB, a target terminal whose distance to the geographic location indicated by the geographic location information “B” is within the set distance threshold can be determined according to the geographic location information “B” and location information of each terminal.

A second request is sent to the target terminal. The second request includes content information “sunset” of the target picture and “50 RMB” required to pay for the target picture.

Assuming that four pictures sent by the target terminal are received, which are a picture 1, a picture 2, a picture 3 and a picture 4, respectively. Thumbnails of these four pictures are generated, and the thumbnails of the four pictures are sent to the first terminal. The first terminal receives the thumbnails of the four pictures and selects one from them. Assuming that the picture 3 is selected, and then the picture 3 is taken as the confirmed picture, and payment information is sent to the server.

The server receives the payment information sent by the first terminal and determines the picture 3 as the target picture. The payment information includes information of taking the picture 3 as the confirmed picture and payment confirmation information of the picture 3.

Then, the server deducts 50 RMB from the account corresponding to the user logging onto the first terminal and adds 50 RMB to the account corresponding to the user logging onto the target terminal that sends the picture 3.

The server sends the picture 3 to the first terminal.

By applying embodiments illustrated in FIG. 3 of the present disclosure, the server includes accounts corresponding to users logging onto respective terminals, such that an account corresponding to a user logging onto the first terminal can pay an account corresponding to a user logging onto the target terminal that sends the target picture, and the fee required to pay for the target picture is added in the second request sent to the target terminal, the response rate of the target terminal is increased, probability of the first terminal receiving satisfactory pictures is increased, and user satisfaction is improved.

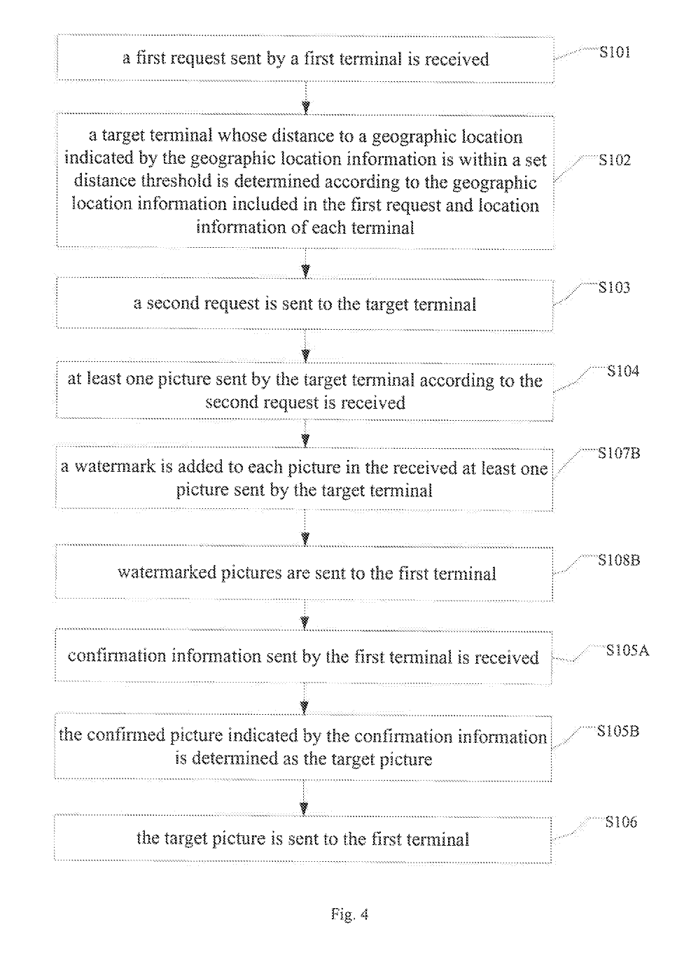

FIG. 4 is a fourth flow chart of a method for acquiring a picture according to an embodiment of the present disclosure. Embodiments illustrated in FIG. 4 are based on the embodiments illustrated in FIG. 1 of the present disclosure, block S107B and S108B are added before block S105.

At block S107B, a watermark is added to each picture in the received at least one picture sent by the target terminal.

At block S108B, watermarked pictures are sent to the first terminal.

Block S105 may include block S105A and block S105B.

At block S105A, confirmation information sent by the first terminal is received. The confirmation information includes information of confirmed picture.

At block S105B, the confirmed picture indicated by the confirmation information is determined as the target picture.

Assuming that four pictures sent by the target terminal are received, which are a picture 1, a picture 2, a picture 3 and a picture 4, respectively. A watermark is added to each picture, and watermarked pictures are sent to the first terminal. The first terminal receives these four watermarked pictures and selects one from them. Assuming that the picture 3 is selected, and then the picture 3 is determined as the confirmed picture, and confirmation information is sent to the server. The server receives the confirmation information sent by the first terminal, the confirmation information includes information of taking the picture 3 as the confirmed picture, and then the picture 3 is determined as the target picture.

In embodiments of the present disclosure, the received at least one picture sent by the target terminal can be filtered, and the target picture can be determined in the filtered at least one picture. In detail, the pictures may be filtered by setting a resolution threshold, and a picture with a resolution less than the threshold may be filtered out, and then the target picture can be determined in the filtered pictures.

Assuming that four pictures sent by the target terminal are received, which are a picture 1, a picture 2, a picture 3 and a picture 4, respectively. The resolution of the picture 1 is 800×600, the resolution of the picture 2 is 1024×768, the resolution of the picture 3 is 320×240, the resolution of the picture 4 is 800×600, the set resolution threshold is 800×600, and then the picture 3 with the resolution less than the threshold may be filtered out, and watermarks can be added to the picture 1, the picture 2 and the picture 4, and the watermarked pictures can be sent to the first terminal.

The first terminal receives these three watermarked pictures and selects one from them. Assuming that the picture 2 is selected, and then the picture 2 is taken as the confirmed picture, and confirmation information is sent to the server. The server receives the confirmation information sent by the first terminal, the confirmation information includes information of taking the picture 2 as the confirmed picture, and the picture 2 is determined as the target picture.

By applying embodiments illustrated in FIG. 4 of the present disclosure, a first request for acquiring a target picture sent by a first terminal is received, the first request includes content information of the target picture and geographic location information for acquiring the target picture, a target terminal whose distance to a geographic location indicated by the geographic location information is within the set distance threshold is determined, and the request for acquiring the target picture is sent to the target terminal, watermarks are added to pictures sent by the target terminal, and the watermarked pictures are sent to the first terminal to allow the first terminal to select, the target picture is determined according to the selection of the first terminal, and the target picture is sent to the first terminal that needs to acquire the target picture, latest pictures that users need can be acquired in real time, and user satisfaction can be improved.

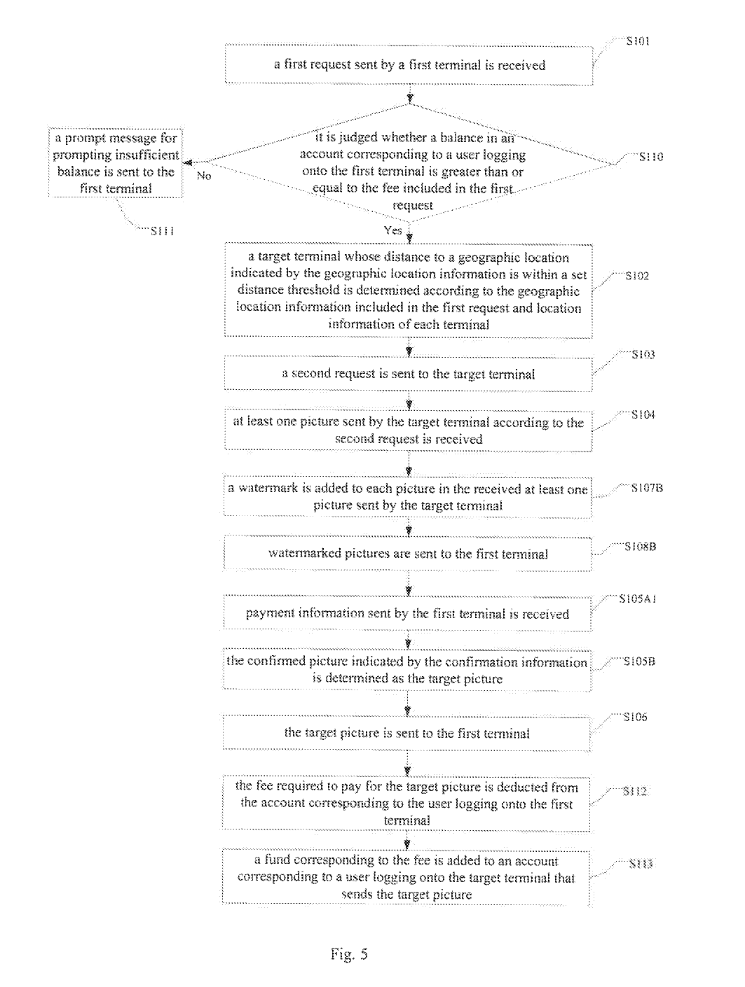

FIG. 5 is a fifth flow chart of a method for acquiring a picture according to an embodiment of the present disclosure. Embodiments illustrated in FIG. 5 are based on the embodiments illustrated in FIG. 4 of the present disclosure. The server includes accounts corresponding to users logging onto respective terminals, and each of the first request and the second request further includes a fee required to pay for the target picture. After block S101, followings may be included.

At block S110, it is judged whether a balance in an account corresponding to a user logging onto the first terminal is greater than or equal to the fee included in the first request, if yes, block S102 is performed, and if no, block S111 is performed.

At block S111, a prompt message for prompting insufficient balance is sent to the first terminal.

Block S105A may include block S105A1. At block 105A1, payment information sent by the first terminal is received. The payment information includes information of the confirmed picture and payment confirmation information of the confirmed picture.

After block S105B, followings may be included.

At block S112, the fee required to pay for the target picture is deducted from the account corresponding to the user logging onto the first terminal.

At block S113, a fund corresponding to the fee is added to an account corresponding to a user logging onto the target terminal that sends the target picture.

In an actual application, in order to increase a response rate of the target terminal, each of the first request and the second request may include the fee required to pay for the target picture. Correspondingly, the server may include accounts corresponding to users logging onto respective terminals.

Assuming that the fee required to pay for the target picture is “50 RMB”, and the first request includes content information “sunset” of the target picture, geographic location information “B” for acquiring the target picture and “50 RMB” required to pay for the target picture. After the first request is received, it is judged whether a balance in the account corresponding to the user logging onto the first terminal is greater than or equal to 50 RMB required to pay for the target picture. Assuming that the balance in the account corresponding to the user logging onto the first terminal is 20 RMB, a prompt message for prompting insufficient balance may be sent to the first terminal. Assuming that the balance in the account corresponding to the user logging onto the first terminal is 80 RMB, a target terminal whose distance to the geographic location indicated by the geographic location information “B” is within the set distance threshold can be determined according to the geographic location information “B” and location information of each terminal.

A second request is sent to the target terminal. The second request includes content information “sunset” of the target picture and “50 RMB” required to pay for the target picture.

Assuming that four pictures sent by the target terminal are received, which are a picture 1, a picture 2, a picture 3 and a picture 4, respectively. A watermark is added to each picture, and watermarked pictures are sent to the first terminal. The first terminal receives these four watermarked pictures and selects one from them. Assuming that the picture 3 is selected, and then the picture 3 is determined as the confirmed picture, and payment information is sent to the server.

The server receives the payment information sent by the first terminal and determines the picture 3 as the target picture. The payment information includes information of taking the picture 3 as the confirmed picture and payment confirmation information of the picture 3.

Then, the server deducts 50 RMB from the account corresponding to the user logging onto the first terminal and adds 50 RMB to the account corresponding to the user logging onto the target terminal that sends the picture 3.

The server sends the picture 3 to the first terminal.

By applying embodiments illustrated in FIG. 5 of the present disclosure, the server includes accounts corresponding to users logging onto respective terminals, such that an account corresponding to a user logging onto the first terminal can pay an account corresponding to a user logging onto the target terminal that sends the target picture, and the fee required to pay for the target picture is added in the second request sent to the target terminal, the response rate of the target terminal is increased, probability of the first terminal receiving satisfactory pictures is increased, and user satisfaction is improved.

Corresponding to the foregoing method embodiments, embodiments of the present disclosure further provide a device for acquiring a picture.

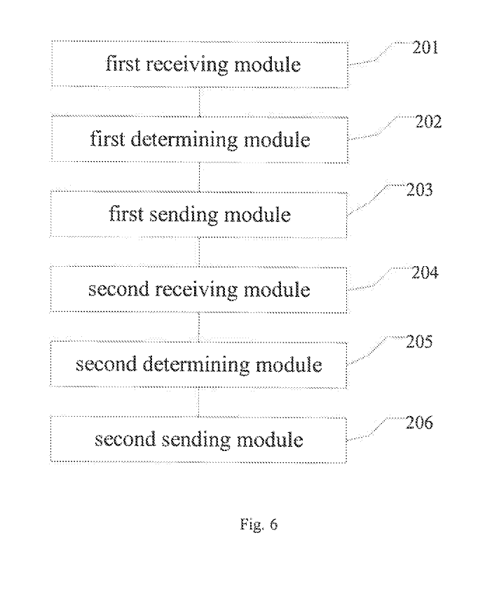

FIG. 6 is a first block diagram of a device for acquiring a picture according to an embodiment of the present disclosure. The device may include a first receiving module 201, a first determining module 202, a first sending module 203, a second receiving module 204, a second determining module 205 and a second sending module 206.

The first receiving module 201 is configured to receive a first request sent by a first terminal. The first request includes content information of a target picture and geographic location information for acquiring the target picture.

The first determining module 202 is configured to determine a target terminal whose distance to a geographic location indicated by the geographic location information is within a set distance threshold according to the geographic location information and location information of each terminal.

The first sending module 203 is configured to send a second request to the target terminal. The second request includes the content information of the target picture.

The second receiving module 204 is configured to receive at least one picture sent by the target terminal according to the second request.

The second determining module 205 is configured to determine the target picture in the received at least one picture sent by the target terminal.

In an actual application, the second determining module 205 is configured to determine any picture in the received at least one picture as the target picture.

The second sending module 206 is configured to send the target picture to the first terminal.

By applying embodiments illustrated in FIG. 6 of the present disclosure, a first request for acquiring a target picture sent by a first terminal is received, the first request includes content information of the target picture and geographic location information for acquiring the target picture, a target terminal whose distance to a geographic location indicated by the geographic location information is within the set distance threshold is determined, and the request for acquiring the target picture is sent to the target terminal, the target picture is determined from pictures sent by the target terminal, and the target picture is sent to the first terminal that needs to acquire the target picture, latest pictures taken by users at a geographic location can be acquired in real time, and user satisfaction can be improved.

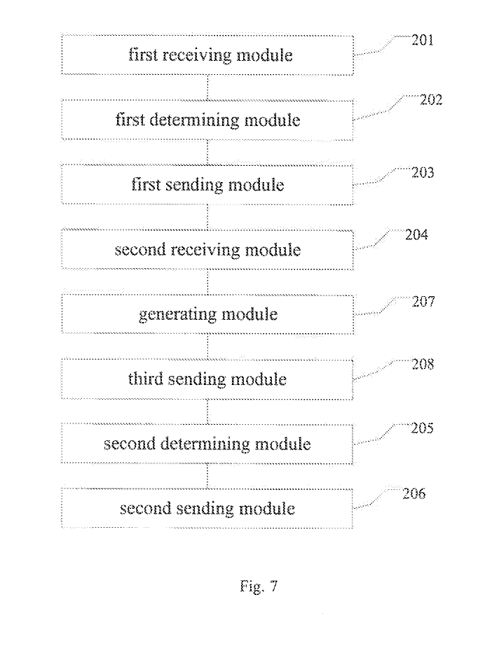

FIG. 7 is a second block diagram of a device for acquiring a picture according to an embodiment of the present disclosure. Embodiments illustrated in FIG. 7 are based on the embodiments illustrated in FIG. 6 of the present disclosure. The device further includes a generating module 207 and a third sending module 208.

The generating module 207 is configured to generate a thumbnail of each picture in the received at least one picture sent by the target terminal.

The third sending module 208 is configured to send the thumbnails of respective picture to the first terminal.

The second determining module 205 may be configured to receive confirmation information sent by the first terminal, in which the confirmation information includes information of confirmed picture; and determine the confirmed picture as the target picture.

In embodiments of the present disclosure, each of the first request and the second request further may include a fee required to pay for the target picture.

The determining module 205 may be configured to receive payment information sent by the first terminal, in which the payment information includes information of the confirmed picture and payment confirmation information of the confirmed picture; and determine the confirmed picture as the target picture.

By applying embodiments illustrated in FIG. 7 of the present disclosure, a first request for acquiring a target picture sent by a first terminal is received, the first request includes content information of the target picture and geographic location information for acquiring the target picture, a target terminal whose distance to a geographic location indicated by the geographic location information is within the set distance threshold is determined, and the request for acquiring the target picture is sent to the target terminal, thumbnails of pictures are generated according to the pictures sent by the target terminal, and the thumbnails of the pictures are sent to the first terminal to allow the first terminal to select, the target picture is determined according to the selection of the first terminal, and the target picture is sent to the first terminal that needs to acquire the target picture, latest pictures that users need can be acquired in real time, and user satisfaction can be improved.

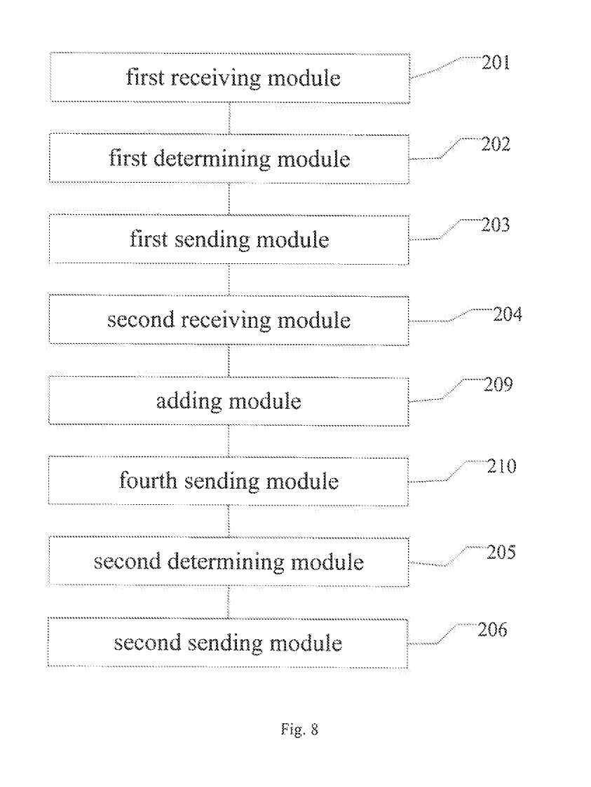

FIG. 8 is a third block diagram of a device for acquiring a picture according to an embodiment of the present disclosure. Embodiments illustrated in FIG. 8 are based on the embodiments illustrated in FIG. 6 of the present disclosure. The device further includes an adding module 209 and a fourth sending module 210.

The adding module 209 is configured to add a watermark to each picture in the received at least one picture sent by the target terminal.

The fourth sending module 210 is configured to send watermarked pictures to the first terminal.

The second determining module 205 may be configured to receive confirmation information sent by the first terminal, in which the confirmation information includes information of confirmed picture; and determine the confirmed picture as the target picture.

In embodiments of the present disclosure, each of the first request and the second request further may include a fee required to pay for the target picture.

The determining module 205 may be configured to receive payment information sent by the first terminal, in which the payment information includes information of the confirmed picture and payment confirmation information of the confirmed picture; and determine the confirmed picture as the target picture.

By applying embodiments illustrated in FIG. 8 of the present disclosure, a first request for acquiring a target picture sent by a first terminal is received, the first request includes content information of the target picture and geographic location information for acquiring the target picture, a target terminal whose distance to a geographic location indicated by the geographic location information is within the set distance threshold is determined, and the request for acquiring the target picture is sent to the target terminal, watermarks are added to pictures sent by the target terminal, and the watermarked pictures are sent to the first terminal to allow the first terminal to select, the target picture is determined according to the selection of the first terminal, and the target picture is sent to the first terminal that needs to acquire the target picture, latest pictures that users need can be acquired in real time, and user satisfaction can be improved.

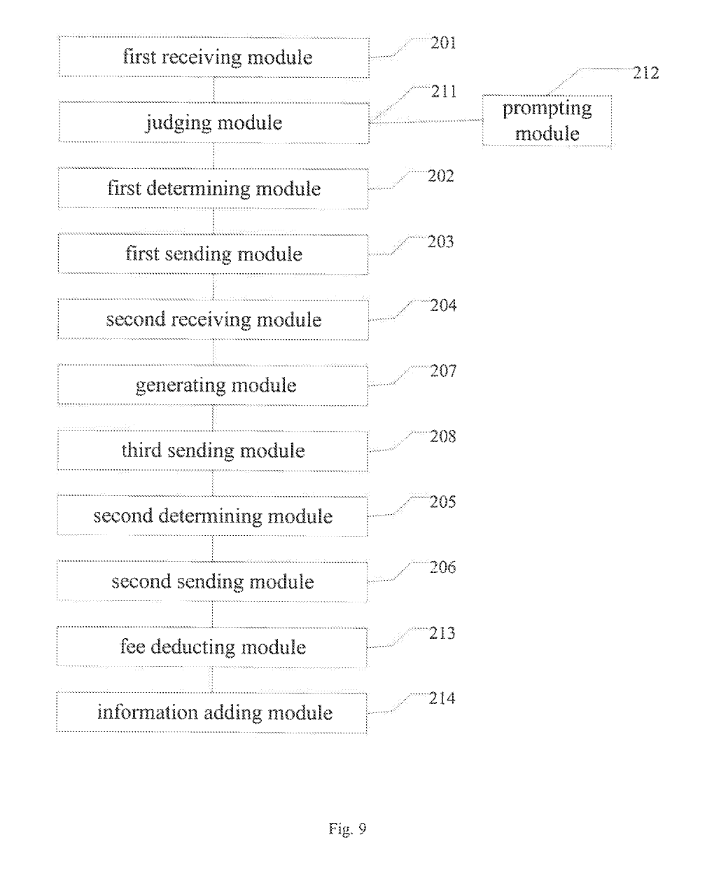

FIG. 9 is a fourth block diagram of a device for acquiring a picture according to an embodiment of the present disclosure. Embodiments illustrated in FIG. 9 are based on the embodiments illustrated in FIG. 7 of the present disclosure. The server includes accounts corresponding to users logging onto respective terminals, and each of the first request and the second request further includes a fee required to pay for the target picture. The device for acquiring a picture may further include a judging module 211 and a prompting module 212.

The judging module 211 is configured to judge whether a balance in an account corresponding to a user logging onto the first terminal is greater than or equal to the fee included in the first request, trigger the first determining module 202 if yes, and trigger a prompting module 212 if no.

The prompting module 212 is configured to send a prompt message for prompting insufficient balance to the first terminal.

The second determining module 205 is configured to receive payment information sent by the first terminal, in which the payment information includes information of the confirmed picture and payment confirmation information of the confirmed picture; and determine the confirmed picture as the target picture.

The device further includes a fee deducting module 213 and an information adding module 214.

The fee deducting module 213 is configured to deduct the fee required to pay for the target picture from the account corresponding to the user logging onto the first terminal.

The information adding module 214 is configured to add a fund corresponding to the fee to an account corresponding to a user logging onto the target terminal that sends the target picture.

The judging module 211, the prompting module 212, the fee deducting module 213 and the information adding module 214 may be added on the basis of embodiments illustrated in FIG. 8.

By applying embodiments illustrated in FIG. 9 of the present disclosure, the server includes accounts corresponding to users logging onto respective terminals, such that an account corresponding to a user logging onto the first terminal can pay an account corresponding to a user logging onto the target terminal that sends the target picture, and the fee required to pay for the target picture is added in the second request sent to the target terminal, the response rate of the target terminal is increased, probability of the first terminal receiving satisfactory pictures is increased, and user satisfaction is improved.

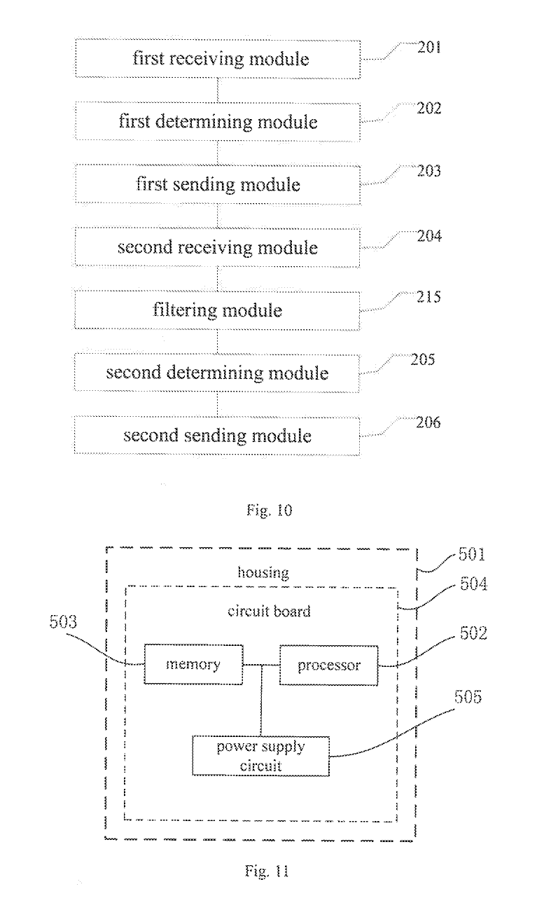

FIG. 10 is a fifth block diagram of a device for acquiring a picture according to an embodiment of the present disclosure. Embodiments illustrated in FIG. 10 are based on the embodiments illustrated in FIG. 6 of the present disclosure. The device further includes a filter module 215.

The filtering module 215 is configured to filter the received at least one picture, such that the target picture is determined in the filtered at least one picture.

The filtering module 215 may also be added on the basis of FIG. 7, FIG. 8 or FIG. 9.

By applying embodiments illustrated in FIG. 10 of the present disclosure, a first request for acquiring a target picture sent by a first terminal is received, the first request includes content information of the target picture and geographic location information for acquiring the target picture, a target terminal whose distance to a geographic location indicated by the geographic location information is within the set distance threshold is determined, and the request for acquiring the target picture is sent to the target terminal, the received at least one picture sent by the target terminal is filtered, and the target picture is determined in the filtered at least one picture, and the target picture is sent to the first terminal that needs to acquire the target picture, latest pictures that users need can be acquired in real time, and user satisfaction can be improved.

In addition, embodiments of the present disclosure further provide a server. As illustrated in FIG. 11, the server includes a housing 501, a processor 502, a memory 503, a circuit board 504 and a power supply circuit 505. The circuit board 504 is disposed in a space enclosed by the housing 501. The processor 502 and the memory 503 are positioned on the circuit board 504. The power supply circuit 505 is configured to provide power for respective circuits or components of the mobile terminal. The memory 503 is configured to store executable program codes. The processor 502 is configured to run a program corresponding to the executable program codes by reading the executable program codes stored in the memory 503, to perform following operations: receiving a first request sent by a first terminal, in which the first request includes content information of a target picture and geographic location information for acquiring the target picture; determining a target terminal according to the geographic location information and location information of each terminal, in which a distance between the target terminal and a geographic location indicated by the geographic location information is within a set distance threshold; sending a second request to the target terminal, in which the second request includes the content information of the target picture; receiving at least one picture sent by the target terminal according to the second request; and determining the target picture in the received at least one picture, and sending the target picture to the first terminal.

The server may provide a computation service, and may include a processor, a hardware, a memory, a system bus, etc. The server has a similar architecture as a common computer, but has a high standard on processing ability, stability, reliability, security, expandability, and manageability for proving a more reliable service.

In addition, embodiments of the present disclosure further provide a storage medium. The storage medium is configured to store an application program that when executed, performs the method for acquiring a picture according to embodiments of the present disclosure. In detail, the method for acquiring a picture according to embodiments of the present disclosure may include: receiving a first request sent by a first terminal, in which the first request includes content information of a target picture and geographic location information for acquiring the target picture; determining a target terminal according to the geographic location information and location information of each terminal, in which a distance between the target terminal and a geographic location indicated by the geographic location information is within a set distance threshold; sending a second request to the target terminal, in which the second request includes the content information of the target picture; receiving at least one picture sent by the target terminal according to the second request; and determining the target picture in the received at least one picture, and sending the target picture to the first terminal.

In addition, embodiments according to the present disclosure provide an application program that when executed, performs the method for acquiring a picture according to embodiments of the present disclosure. In detail, the method for acquiring a picture according to embodiments of the present disclosure may include: receiving a first request sent by a first terminal, in which the first request includes content information of a target picture and geographic location information for acquiring the target picture; determining a target terminal according to the geographic location information and location information of each terminal, in which a distance between the target terminal and a geographic location indicated by the geographic location information is within a set distance threshold; sending a second request to the target terminal, in which the second request includes the content information of the target picture; receiving at least one picture sent by the target terminal according to the second request; and determining the target picture in the received at least one picture, and sending the target picture to the first terminal.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

The embodiments in the specification are described in a related manner, and the same or similar parts between the various embodiments may refer to each other, and the emphasis of each embodiment is on differences from other embodiments. In particular, for the device embodiment, since it is similar to the method embodiment, the description is relatively simple, and the related parts may refer to the descriptions of the method embodiment.

It would be understood by those skilled in the art that, all or a part of the steps carried by the method in the above-described embodiments may be completed by relevant hardware instructed by a program. The program may be stored in a computer readable storage medium, such as ROM/RAM, a magnetic disk, an optical disk, or the like.

The foregoing descriptions are merely preferred embodiments of the present disclosure, and are not intended to limit protection scopes of the present disclosure. Any modification, equivalent replacement, improvement and the like made within the spirit and principle of the present disclosure should be included in the protection scopes of the present disclosure.

What is claimed is:

1. A method for acquiring a picture, applied to a server, comprising:
receiving a first request sent by a first terminal, wherein the first request comprises content information of a target picture and geographic location information for acquiring the target picture;
determining a target terminal according to the geographic location information and location information of each terminal, wherein a distance between the target terminal and a geographic location indicated by the geographic location information is within a set distance threshold;
sending a second request to the target terminal, wherein the second request comprises the content information of the target picture;
receiving at least one picture sent by the target terminal according to the second request; and
determining the target picture in the received at least one picture, and sending the target picture to the first terminal.

2. The method according to claim 1, wherein determining the target picture in the received at least one picture comprises:
determining any picture in the received at least one picture as the target picture.

3. The method according to claim 1, wherein before determining the target picture in the received at least one picture, the method further comprises:
generating a thumbnail of each picture in the received at least one picture; and
sending the thumbnails of respective pictures to the first terminal,
determining the target picture in the received at least one picture comprises:
receiving confirmation information sent by the first terminal, wherein the confirmation information comprises information of confirmed picture; and
determining the confirmed picture as the target picture.

4. The method according to claim 1, wherein before determining the target picture in the received at least one picture, the method further comprises:
adding a watermark to each picture in the received at least one picture; and
sending watermarked pictures to the first terminal,
determining the target picture in the received at least one picture comprises:
receiving confirmation information sent by the first terminal, wherein the confirmation information comprises information of confirmed picture; and
determining the confirmed picture as the target picture.

5. The method according to claim 3, wherein the server comprises accounts corresponding to users logging onto respective terminals, each of the first request and the second request further comprises a fee required to pay for the target picture;
after receiving the first request sent by the first terminal, the method further comprises:
judging whether a balance in an account corresponding to a user logging onto the first terminal is greater than or equal to the fee;
sending a prompt message for prompting insufficient balance to the first terminal when the balance in the account corresponding to the user logging onto the first terminal is less than the fee; and
determining the target terminal according to the geographic location information and the location information of each terminal when the balance in the account corresponding to the user logging onto the first terminal is greater than or equal to the fee, receiving the confirmation information sent by the first terminal comprises:
receiving payment information sent by the first terminal, wherein the payment information comprises information of the confirmed picture and payment confirmation information of the confirmed picture,
after determining the confirmed picture as the target picture, the method further comprises:
deducting the fee from the account corresponding to the user logging onto the first terminal; and
adding a fund corresponding to the fee to an account corresponding to a user logging onto the target terminal that sends the target picture.

6. The method according to claim 1, wherein determining the target picture in the received at least one picture comprises:
filtering the received at least one picture, and determining the target picture in the filtered at least one picture.

7. A device for acquiring a picture, applied to a server, comprising:
a processor, and
a memory, configured to store a computer program comprising program instructions;
wherein the processor is configured to:
receive a first request sent by a first terminal, wherein the first request comprises content information of a target picture and geographic location information for acquiring the target picture;
determine a target terminal according to the geographic location information and location information of each terminal, wherein a distance between the target terminal and a geographic location indicated by the geographic location information is within a set distance threshold;
send a second request to the target terminal, wherein the second request comprises the content information of the target picture;
receive at least one picture sent by the target terminal according to the second request;
determine the target picture in the received at least one picture; and
send the target picture to the first terminal.

8. The device according to claim 7, wherein the processor is configured to:
determine any picture in the received at least one picture as the target picture.

9. The device according to claim 7, wherein the processor is further configured to:
generate a thumbnail of each picture in the received at least one picture;
send the thumbnails of respective picture to the first terminal;
receive confirmation information sent by the first terminal, wherein the confirmation information comprises information of confirmed picture; and
determine the confirmed picture as the target picture.

10. The device according to claim 7, wherein the processor is further configured to:
add a watermark to each picture in the received at least one picture; send watermarked pictures to the first terminal;
receive confirmation information sent by the first terminal, wherein the confirmation information comprises information of confirmed picture; and
determine the confirmed picture as the target picture.

11. The device according to claim 9, wherein the server comprises accounts corresponding to users logging onto respective terminals, each of the first request and the second request further comprises a fee required to pay for the target picture, the processor is further configured to:
judge whether a balance in an account corresponding to a user logging onto the first terminal is greater than or equal to the fee;
send a prompt message for prompting insufficient balance to the first terminal when the balance in the account corresponding to the user logging onto the first terminal is less than the fee;
determine the target terminal according to the geographic location information and the location information of each terminal when the balance in the account corresponding to the user logging onto the first terminal is greater than or equal to the fee;
receive payment information sent by the first terminal, wherein the payment information comprises information of the confirmed picture and payment confirmation information of the confirmed picture;
determine the confirmed picture as the target picture;
deduct the fee from the account corresponding to the user logging onto the first terminal; and
add a fund corresponding to the fee to an account corresponding to a user logging onto the target terminal that sends the target picture.

12. The device according to claim 7, wherein the processor is further configured to:
filter the received at least one picture, and determine the target picture in the filtered at least one picture.

13. A server, comprising: a housing, a processor, a memory, a circuit board and a power supply circuit, wherein,
the circuit board is disposed in a space enclosed by the housing;
the processor and the memory are positioned on the circuit board;
the power supply circuit is configured to provide power for respective circuits or components of the mobile terminal;
the memory is configured to store executable program codes;
the processor is configured to run a program corresponding to the executable program codes by reading the executable program codes stored in the memory, to perform following operations:
receiving a first request sent by a first terminal, wherein the first request comprises content information of a target picture and geographic location information for acquiring the target picture;
determining a target terminal according to the geographic location information and location information of each terminal, wherein a distance between the target terminal and a geographic location indicated by the geographic location information is within a set distance threshold;
sending a second request to the target terminal, wherein the second request comprises the content information of the target picture;
receiving at least one picture sent by the target terminal according to the second request; and
determining the target picture in the received at least one picture, and sending the target picture to the first terminal.

14. The server according to claim 13, wherein the processor is configured to determine the target picture in the received at least one picture by acts of:
determining any picture in the received at least one picture as the target picture.

15. The server according to claim 13, wherein the processor is further configured to run a program corresponding to the executable program codes, to perform acts of:
generating a thumbnail of each picture in the received at least one picture; and
sending the thumbnails of respective pictures to the first terminal,
wherein the processor is configured to determine the target picture in the received at least one picture by acts of:
receiving confirmation information sent by the first terminal, wherein the confirmation information comprises information of confirmed picture; and
determining the confirmed picture as the target picture.

16. The server according to claim 13, wherein the processor is further configured to run a program corresponding to the executable program codes, to perform acts of:
adding a watermark to each picture in the received at least one picture; and
sending watermarked pictures to the first terminal,
wherein the processor is configured to determine the target picture in the received at least one picture by acts of:
receiving confirmation information sent by the first terminal, wherein the confirmation information comprises information of confirmed picture; and
determining the confirmed picture as the target picture.

17. The server according to claim 15, wherein the server comprises accounts corresponding to users logging onto respective terminals, each of the first request and the second request further comprises a fee required to pay for the target picture, the processor is further configured to run a program corresponding to the executable program codes, to perform acts of:
judging whether a balance in an account corresponding to a user logging onto the first terminal is greater than or equal to the fee;
sending a prompt message for prompting insufficient balance to the first terminal when the balance in the account corresponding to the user logging onto the first terminal is less than the fee; and
determining the target terminal according to the geographic location information and the location information of each terminal when the balance in the account corresponding to the user logging onto the first terminal is greater than or equal to the fee,
where the processor is configured to receive the confirmation information sent by the first terminal by acts of:
receiving payment information sent by the first terminal, wherein the payment information comprises information of the confirmed picture and payment confirmation information of the confirmed picture.

18. The server according to claim 17, wherein processor is further configured to run a program corresponding to the executable program codes, to perform acts of:
deducting the fee from the account corresponding to the user logging onto the first terminal; and
adding a fund corresponding to the fee to an account corresponding to a user logging onto the target terminal that sends the target picture.

19. The server according to claim 13, wherein the processor is configured to determine the target picture in the received at least one picture by acts of:
filtering the received at least one picture, and determining the target picture in the filtered at least one picture.
